(19) United States
(12) Patent Application Publication
(10) Pub. No.: US 2018/0204480 A1
(43) Pub. Date: Jul. 19, 2018

(54) COGNITIVE TRAINING SYSTEM

(71) Applicant: CHAO-WEI CHEN, Kaohsiung City (TW)

(72) Inventor: CHAO-WEI CHEN, Kaohsiung City (TW)

(21) Appl. No.: 15/872,976

(22) Filed: Jan. 16, 2018

(30) Foreign Application Priority Data
Jan. 18, 2017 (TW) 106101744

(51) Int. Cl. G09B 19/00; G09B 7/06

(52) U.S. Cl. CPC G09B 19/00; G09B 7/06

(57) ABSTRACT

A cognitive training system including a first operation terminal, a second operation terminal and a system terminal. A cognitive training media is edited by the first operation terminal and being saved in the system terminal. The system terminal is used for sending the cognitive training media to the second operation terminal and receiving feedback information including a cognitive training result according to the cognitive training media, and analyzing whether the cognitive training result is correct and returning the analysis, so as to achieve the effect of cognitive training. Thereby, the present invention can provide a customized cognitive training service so as to improve the training effect.

### CROSS-REFERENCE TO RELATED APPLICATIONS

This application claims the priority of Republic of China Patent Application No. 106101744 filed on Jan. 18, 2017, in the State Intellectual Property Office of the R.O.C., the disclosure of which is incorporated herein by reference.

### BACKGROUND OF THE INVENTION

### Field of the Invention

The present invention is related to a cognitive rehabilitation and training technology field, and more specifically to a cognitive training system.

### Descriptions of the Related Art

A cognitive ability means a brain ability of thinking, memory and identification. Nevertheless, a cognitive function disorder is a common clinical disorder, which is common in diseases such as various brain damages and Alzheimer's disease (senile dementia). As a patient suffers from a cognitive function disorder, both living quality and self-care ability will be influenced significantly to burden both family and society seriously. Moreover, a child may have issues of solitariness, autism, timidity, diffidence, bad temper, etc. in case of poor cognitive ability.

Conventionally, the recovery training for cognitive function disorder is mainly based on repeated memory and professional consultation, such as picture memory training in a manual manner or by means of computer aiding. Such conventional method for cognitive function rehabilitation training has been proved to be actually effective, but is still insufficient:

At first, the conventional cognitive rehabilitation training uses single but complex means, and needs professional consultation in most cases, so that there are significant temporal and spatial limits during the cognitive rehabilitation training; Next, a pure picture memory training usually deflects from an actual living environment of the patient, so that the treatment effect is usually not as expected after the patient returns home or society although some portion of the cognitive ability of the patient is improved. Therefore, a training with respect to real living ability has to be conducted for the patient in order for better recovery of the patient.

In light of above, how to improve the treatment effect by improving the conventional cognitive ability rehabilitation training is the technical subject of the application to be solved.

### SUMMARY OF THE INVENTION

In view of the above and other drawbacks of the conventional technology, a primary object of the invention is to provide a cognitive training system, which can provide a customized cognitive training service so as to improve the training effect.

Another object of the invention is to provide a cognitive training system, which may prompt a training medium uploaded by a patient, have the effect of cognitive aiding.

Another one object of the invention is to provide a cognitive training system, which may integrate 3D situational interaction to improve motivation of a user for training.

For the objects said above and for other objects, the invention provides a cognitive training system, including: a first operation terminal for providing input of a sampling feature, a first training medium and a first learning trigger instruction; a second operation terminal having an input module and a prompt module, wherein the input module is used for providing input of a cognitive result; and a system terminal having: a database; a sampling extraction module for extracting a feature sample matching the sampling feature from the first training medium, and storing the sampling feature and the feature sample matching therewith in the database; and a cognitive training module for receiving the first learning trigger instruction of the first operation terminal to activate execution of a cognitive training program in order to provide a cognitive training service for the second operation terminal, and communicatively connecting with the input module and the prompt module of the second operation terminal, such that the cognitive training module triggers the cognitive training program when receiving the first learning trigger instruction for the prompt module to prompt the feature sample stored in the database, followed by receiving the cognitive result which is input by the input module based on the prompted feature sample to determine that the cognitive result is correct as the cognitive result matches with the sampling feature stored in the database, or to determine that the cognitive result is incorrect if there is mismatch.

Preferably, the system terminal further includes a first statistic module, which performs statistic analysis for accuracy of the cognitive result of the feature sample trained by the cognitive training module for the cognitive training module to provide an enhancement training for the feature sample of the cognitive result with lower accuracy.

Preferably, the input module further includes capability for providing input of a second training medium and a second learning trigger instruction; and the system terminal further includes a feature analysis module; wherein the cognitive training module is also used for receiving the second learning trigger instruction of the second operation terminal to activate execution of the cognitive training program in order to provide a cognitive aiding service for the second operation terminal, such that the cognitive training module triggers the cognitive training program when receiving the second learning trigger instruction for the input module to input the second training medium, and extract an identification feature in the second training medium by the feature analysis module, followed by searching for a sampling feature matching with the identification feature from the database, and allowing the prompt module to prompt the sampling feature if there is match.

Preferably, the cognitive training module further includes trigger of the cognitive training program when receiving the first, second learning trigger instructions for the prompt module to prompt the sampling feature matching with the feature sample stored in the database when prompting the feature sample stored in the database.

Preferably, the system terminal further includes a second statistic module, which performs statistic analysis with respect to number and frequency of prompts of the sampling feature done by the prompt module to provide an enhancement training for the feature sample matching with the sampling feature with higher number and the frequency of prompts.

Preferably, the first, second training media have a dynamic image medium, a static image medium and an audio medium. The sampling feature is an image feature and/or a voice feature. The sampling feature includes the image feature and/or voice feature of at least one person and/or object, and the sampling feature further include an identification information.

Preferably, the cognitive training module further includes extracting the sampling feature and an identification information included therein as well as the feature sample matching with the sampling feature from the database after receiving the first learning trigger instruction for the prompt module to prompt the extracted feature sample, followed by receiving a cognitive result comprising an input identification information input by the input module, and determining whether the input identification information in the cognitive result matches with the extracted identification information.

Preferably, the cognitive training module further includes extracting the sampling feature and an identification information included therein as well as the feature sample matching with the sampling feature from the database after receiving the first learning trigger instruction for the prompt module to prompt the identification information, followed by receiving a cognitive result comprising an input sampling feature or an input feature sample input by the input module, and determining whether the input sampling feature or the input feature sample in the cognitive result matches with the extracted sampling feature.

Preferably, the cognitive training module further includes transmitting a determination information with respect to correctness or incorrectness of the cognitive result to the prompt module for display.

Preferably, the first operation terminal, the second operation terminal and the system terminal are mounted in one electronic device, which is a desktop electronic device or a portable electronic device.

Preferably, the first operation terminal, the second operation terminal and the system terminal are mounted in at least one electronic device, wherein the electronic device for mounting the second operation terminal is a wearable electronic device, wherein the prompt module of the second operation terminal is capable of 3D situational interaction.

Preferably, the first operation terminal further includes a first retrieval module for retrieving the first training medium, and the second operation terminal further includes a second retrieval module for retrieving the second training medium.

Compared to the conventional technology, a training cognitive system of the present invention may provide self-editing of and storing of a sampling feature and a first training medium in a system terminal by a first operation terminal, in order for activating a training cognitive program upon receiving a first learning trigger instruction, outputting a feature sample extracted from the first training medium to a second operation terminal, and determining a cognitive result input by the second operation terminal, thereby a customized cognitive training service is provided and the purpose of cognitive training is achieved.

Further, the system terminal of the present invention may also receive a second learning trigger instruction input by the second operation terminal and a second training medium it uploads in real time to recognize the second training medium and prompt a matched sampling feature, in order for achieving the effect of cognitive aiding, so that the cognitive training provided by the present invention may be integrated with an actual living environment to improve the effect of the cognitive training considerably.

Moreover, a second system terminal of the present invention is capable of 3D situational interaction, integrating a cognitive training process into a living scenario of the patient to improve enjoyment in the training process and improve motivation of the training.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a fundamental framework diagram showing a cognitive training system according to the present invention.

FIG. 2 is an implementation illustration showing a first statistic module of the cognitive training system according to the present invention.

FIGS. 3 and 4 are a first and a second implementation illustrations illustrating the cognitive training system providing a cognitive aiding training according to the present invention, respectively.

FIG. 5 is an implementation illustration illustrating a second statistic module of the cognitive training system according to the present invention.

FIG. 6 is an implementation illustration illustrating a first retrieval module and a second retrieval module of the cognitive training system according to the present invention.

FIG. 7 is an implementation illustration showing several arrangements of a first operation terminal, a second operation terminal and a system terminal according to the present invention.

FIG. 8 is an implementation illustration showing a first training medium and a sampling feature according to the present invention.

FIGS. 9A to 9C are schematic views showing user operation interfaces of the second operation terminal executing a cognitive training program according to the present invention, respectively.

FIGS. 10A to 10K are implementation illustrations showing user operation interfaces of the cognitive training system executing a cognitive training function according to the present invention, respectively.

FIGS. 11A to 11F are implementation illustrations showing user operation interfaces of the cognitive training system executing a spatial positioning ability training according to the present invention, respectively.

FIG. 11G is an implementation illustration showing a user operation interface of the cognitive training system providing an execution ability training according to the present invention.

FIG. 12 is an implementation illustration showing a user operation interface of the cognitive training system executing an expression ability training according to the present invention.

FIGS. 13A to 13C are implementation illustrations showing user operation interfaces of the cognitive training system executing a calculation ability training according to the present invention, respectively.

FIG. 14 is an implementation illustration showing a user operation interface of the cognitive training system providing a cognitive training mode of short-term memory according to the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

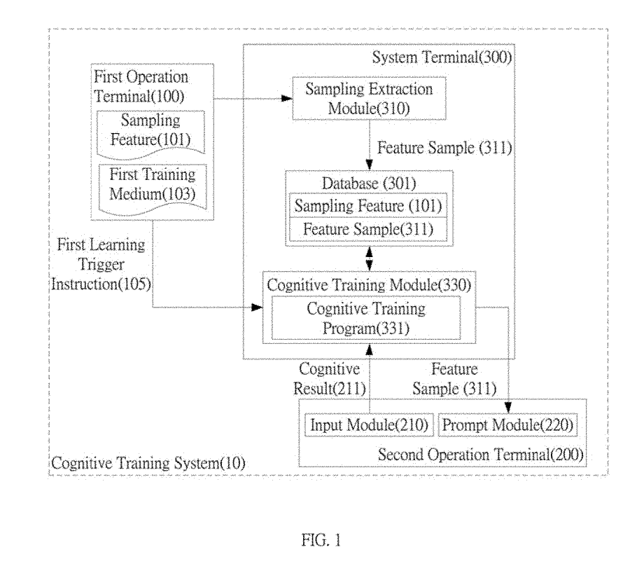

FIG. 1 is a fundamental framework diagram showing a cognitive training system 10 according to the present invention. As shown in the figure, the cognitive training system 10 consists essentially of a first operation terminal 100, a second operation terminal 200 and a system terminal 300. Refer to FIG. 7 in conjunction. In an embodiment of the present invention, the first operation terminal 100, the second operation terminal 200 and the system terminal 300 may be mounted in one or more electronic devices arbitrarily per actual requirement. For example, they may be mounted in the same electronic device A (i.e., implementation 1), such as a desktop electronic device (e.g., computer) or a portable electronic device (e.g., notebook, tablet, smartphone etc.). In an implementation 2, the first operation terminal 100, the second operation terminal 200 and the system terminal 300 are mounted in separate electronic devices A, B and C, respectively, wherein the electronic device A mounting the first operation terminal 100 may be arranged in a doctor terminal for a doctor to edit and set training related information; the electronic device B mounting the second operation terminal 200 may be arranged in a patient terminal to provide cognitive training and aiding for a patient; and the system terminal 300 mounted in the electronic device C may be arranged in a network cloud to store training materials and perform related analysis operations. Moreover, the first operation terminal 100, the second operation terminal 200 and the system terminal 300 may also be arranged in two separate electronic devices A and B, respectively. Specific combination depends on specific application situations. Refer to implementations 3, 4 and 5 in FIG. 7 for details. It should be noted that as the second operation terminal 200 is arranged in an electronic device alone (i.e., implementation 2 or 5), the electronic device for mounting the second operation terminal 200 may be a wearable electronic device (e.g., smart watch, smart ring or smart glasses). Preferably, the electronic device, such as virtual reality (VR) glasses, is capable of 3D situational interaction, which increases fun of cognitive training and improves motivation of the patient for training.

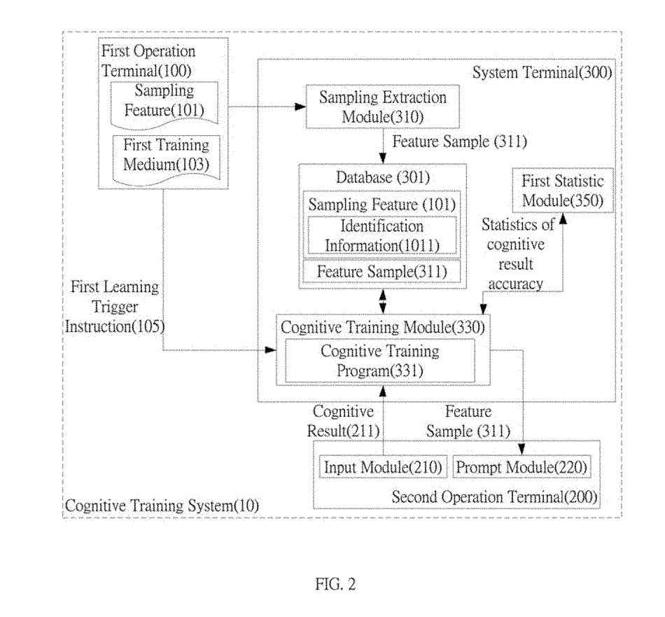

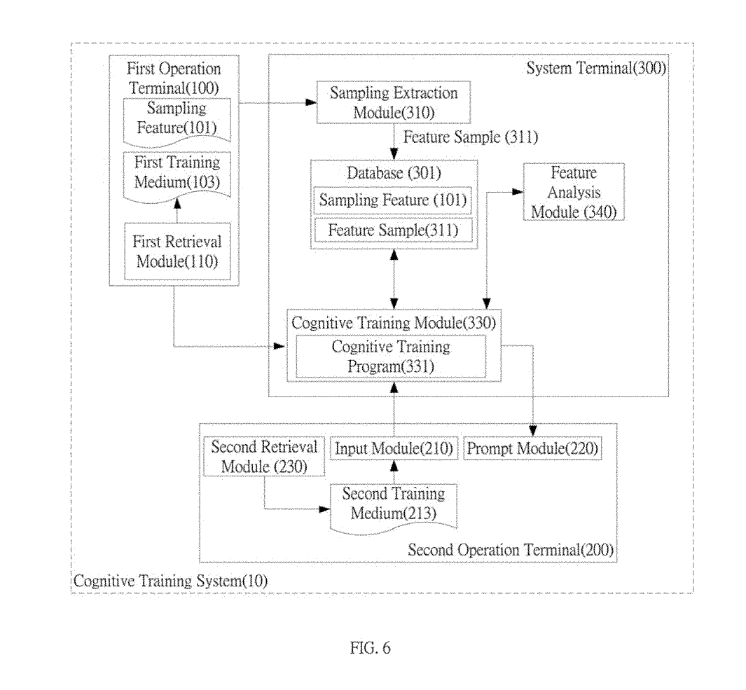

The first operation terminal 100 is used for providing input of a sampling feature 101, a first training medium 103 and a first learning trigger instruction 105. Refer to FIG. 6. In an embodiment, the first operation terminal 100 further includes a first retrieval module 110, such as optical sensor (camera), audio (audio recorder), touch sensor or data transmission line (allowing connection of the cognitive training system 100 to other external digital database for data transmission), for retrieving the first training medium 103, wherein the first training medium 103 may be a dynamic image medium (image datum), a static image medium (photo) and an audio medium (audio record). In correspondence, the sampling feature 101 is an image feature or a voice feature, and the sampling feature 101 includes the image feature and/or voice feature of at least one person (family/friend) and/or object (house, road, ornament or pet etc.). Specifically, Refer to FIG. 8 in conjunction, wherein the first training medium 103 may be a photo of a whole family, including parents, a son and a daughter, while the sampling feature 101 may be, for example, a facial close-up of the “daughter”. Moreover, refer to FIG. 2 in conjunction. The sampling feature 101 may further include an identification information 1011, such that the corresponding identification information 1011 may be edited with respect to the sampling feature 101 when the first operation terminal 100 inputs the sampling feature 101, that is, a corresponding identification information 1011 is edited as a “daughter” with respect to the sampling feature 101 in FIG. 8, and the sampling feature 101 and the identification information 1011 thereof are both stored in a database 301. Moreover, the identification information 1011 may also include text, date, spatial positioning data, etc.

The second operation terminal 200 have an input module 210 and a prompt module 220, wherein the input module 210 is used for providing input of a cognitive result 211 (discussed in detail below).

The system terminal 300 has a database 301, a sampling extraction module 310 and a cognitive training module 330. The sampling extraction module 310 is used to receive the sampling feature 101 and the first training medium 103 input by the first operation terminal 100, according to which a feature sample 311 matching with the sampling feature 101 is extracted from the first training medium 103, and the sampling feature 101 and the feature sample 311 matching therewith are stored in the database 301, that is, the sampling feature 101 and the feature sample 311 are stored in the database 301 in a corresponding association manner. It should be noted that, in the embodiment, the same sampling feature 101 may be associated with the feature sample 311 correspondingly. By example of a portrait, the sampling extraction module 310 utilizes a specific algorithm (face/object recognition technology, audio recognition technology, language process technology, path analysis technology, machine learning technology, etc.) to search text, image or audio data related to facial data in the first training medium 103, and extract the data to generate the feature sample 311, as well as associate and store the feature sample 311 and the sampling feature 101 matched therewith in the database 301. In an embodiment, the sampling extraction module 310 searches the content matching with the sampling feature 101, i.e., the circled content in the first training medium 103, from the photo of the whole family (i.e., the first training medium 103) according to the sampling feature 101 in FIG. 8, i.e., the facial close-up of the “daughter”, and extracts and stores the circled content as the feature sample 311 in the database 301.

The cognitive training module 330 is used for receiving the first learning trigger instruction 105 of the first operation terminal 100 to activate execution of a cognitive training program 331, thereby providing a cognitive training service for the second operation terminal 200. Further, the cognitive training module 330 is in communicative connection with the input module 210 and the prompt module 220 of the second operation terminal 200. Wherein, the cognitive training module 330 triggers the cognitive training program 331 when receiving the first learning trigger instruction 105 for the prompt module 220 to prompt the feature sample 311 stored in the database, followed by receiving the cognitive result 211 which is input by the input module 210 based on the prompted feature sample 311 to determine that the cognitive result 211 is correct as the cognitive result 211 matches with the sampling feature 101 stored in the database 301, or to determine that the cognitive result 211 is incorrect if there is mismatch.

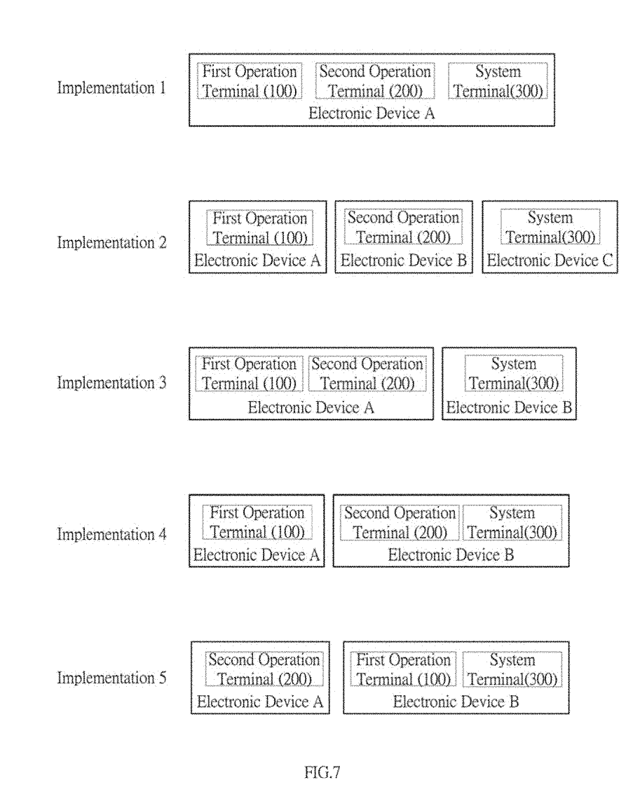

Refer to FIG. 9A. The cognitive training module 330 triggers the cognitive training program 331 when receiving the first learning trigger instruction 105, and extracts the feature sample 311 and the sampling feature 101 matching therewith as well as the identification information 1011 included therein from a plurality of feature samples 311 stored in the database 301 in a random manner (for example, the feature sample 311, the sampling feature 101 and the identification information 1011 thereof related to the “daughter” are extracted in FIG. 9A), as well as outputs the feature sample 311 to the prompt module 220 of the second operation terminal 200 for prompt, in order for the patient of the second operation terminal 200 to identify the displayed feature sample 311. In FIG. 9A, four content options comprising the “identification information 1011” are provided, which are “daughter”, “son”, “wife” and “myself”, respectively. With the input module 210, the patient may select one of the “identification information 1011” as the cognitive training 211 to be returned to the system terminal 300 for the cognitive training module 330 to analyze whether the input identification information matches with the extracted identification information 1011 mentioned above. The input cognitive result 211 is determined to be correct if there is match, or the cognitive result 211 is determined to be incorrect otherwise.

Refer to FIG. 9B. In another embodiment according to the present invention, for a specific application, the cognitive training module 330 triggers the cognitive training program 331 when receiving the first learning trigger instruction 105, and extracts the feature sample 311 and the sampling feature 101 matching therewith as well as the identification information 1011 included therein from a plurality of feature samples 311 stored in the database 301 in a random manner (for example, the feature sample 311, the sampling feature 101 and the identification information 1011 thereof related to the “son” are extracted in FIG. 9B), as well as outputs “son”, which is the identification information 1011, to the prompt module 220 of the second operation terminal 200 for prompt, as well as provides four content options comprising the “feature sample 311/sampling feature 101” for selection (as shown in FIG. 9B). The patient may select one of the content options as the cognitive result 211 to be returned to the system terminal 300 for the cognitive training module 300 to analyze whether the input feature sample or the input sampling feature included in the cognitive result 311 matches with the extracted identification information 1011 mentioned above. The input cognitive result 211 is determined to be correct if there is consistency, or the cognitive result 211 is determined to be incorrect otherwise.

In an embodiment, the cognitive training module 330 further includes transmitting the determination information with respect to correctness or incorrectness of the cognitive result 211 mentioned above to the prompt module 220 of the second operation terminal 200 for display in order for the patient to know.

It should be noted that in providing the cognitive training service mentioned above, the first operation terminal 100 and the second operation terminal 200 of the present invention may be arranged by selecting any mode illustrated in FIG. 7. That is, the cognitive training mode mentioned above is triggered by the doctor as the first operation terminal 100 is arranged in the doctor terminal, while the training mode is triggered by the patient herself/himself as the first operation terminal 200 is arranged in the patient terminal.

Refer to FIG. 2 in conjunction. The system terminal 300 further includes a first statistic module 350, which performs statistic analysis for accuracy of the cognitive result 211 of the feature sample 311 trained by the cognitive training module 330 for the cognitive training module 330 to provide an enhancement training or an adequate training for the feature sample 311 of the cognitive result 211 with lower accuracy. That is, The first statistic module 350 performs statistic analysis for the accuracy of the cognitive result 211 of the feature sample 311 of the “daughter” output by the cognitive training module 330. If the analysis shows that the error rate of the cognitive result 211 input by the patient with respect to the feature sample 311 of the “daughter” is higher, indicating a weaker current cognitive ability of the patient with respect to the “daughter”, then the cognitive training module 330 increases the frequency of outputting the feature sample 311 related to the “daughter” to achieve the effect of the enhancement training.

Furthermore, in addition to the function of cognitive training, the present invention may also provide the training of cognitive aiding. In such operation mode, the second operation terminal 200 is an electronic device (e.g., smartphone, smart ring or smart glasses, etc.) arranged in the patient terminal specially.

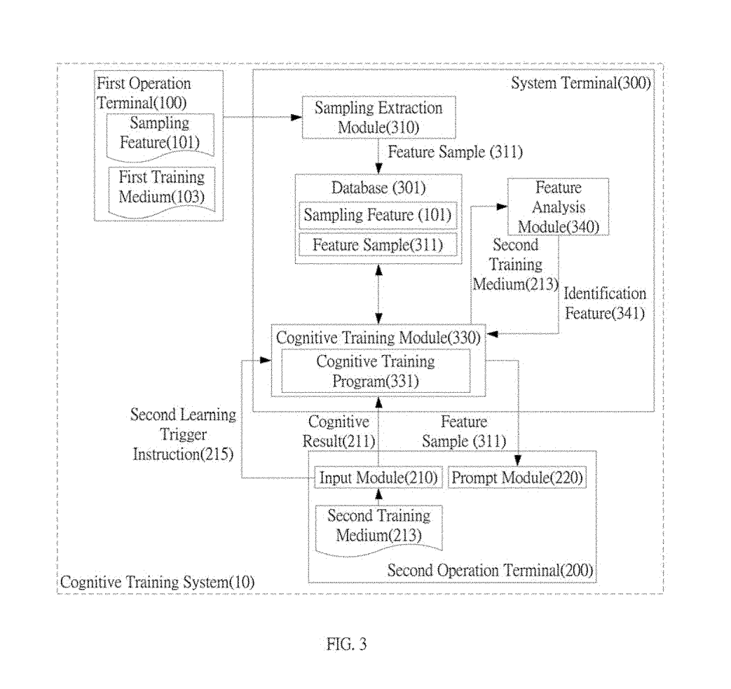

Refer to FIG. 3 in conjunction. In a first embodiment of a cognitive aiding training according to the present invention, the input module 210 of the present invention further includes capability for providing input of the second training medium 213 and the second learning trigger instruction 215. The second operation terminal 200 further includes a second retrieval module 230 (as shown in FIG. 6), such as optical sensor (camera), audio (audio recorder) or touch sensor, for retrieving the second training medium 213. As mentioned above, the second training medium 213 may be a dynamic image medium (image datum), a static image medium (such as photo) and an audio medium (such as audio record). The system terminal 300 further includes a feature analysis module 340, wherein the cognitive training module 330 may also receive the second learning trigger instruction 215 of the second operation terminal 200 to activate execution of the cognitive training program 311, thereby providing a cognitive training service for the second operation terminal 200. Specifically, when a person or object with cognitive disorder is encountered in daily life, the patient may input the second learning trigger instruction 215 by the input module 210 of the second operation terminal 200 at any time for the cognitive training module 330 to activate the cognitive training program 331, and input the second training medium 213 by the input module 210. That is, the patient is allowed to take or record, and upload, for example, either an image, a photo, or an audio for the encountered person or object with the cognitive disorder to the system terminal 300 for the feature analysis module 340 to extract an identification feature 341 in the second training medium 213, such as a facial feature of a person in a portrait, and compare with the sampling feature 101 stored in the database 301 (picture comparison, text comparison, image comparison and audio comparison are all applicable to the present invention) to seek the sampling feature 101 matching with an extracted identification feature 341. If there is match, the prompt module 220 prompts the sampling feature 101 to prompt the identity of the person in the taken photo. Refer to FIG. 9C in conjunction. Preferably, in addition to prompt of the sampling feature 101 matching with the extracted identification feature 341, the prompt module 220 may further prompt the identification information 1011 (i.e., “daughter”) included in the sampling feature 101, and other related feature information. For example, the prompt module 220 may further prompt the name of the “daughter” as “Mary”, and prompt other feature sample 311 related to the “daughter” stored in the database 301. Thereby, the actual living environment of the patient is combined to aid the patient in performing the cognitive training, so that the effect of training is improved. It should be noted that the embodiment mentioned above is described by example of a static image only, but is not limited thereto. It is also applicable to the second training medium 213 in text, image and audio formats. There will be no redundant description.

In a second embodiment of a cognitive aiding training according to the present invention, the present invention may not only provide a real-time cognitive aiding prompt for a person or object with cognitive disorder encountered by a patient in real life, but also utilize existing data in the database 301 to perform a cognitive training. Refer to FIG. 4 in conjunction. The cognitive training module 330 further includes triggering the cognitive training program 331 when receiving the first learning trigger instruction 105 of the first operation terminal 100 or the second learning trigger instruction 215 of the second operation terminal 200, extracting the feature sample 311 and the sampling feature 101 matching therewith from the database 301, and, preferably, being capable of extracting the identification information 1011 related to the sampling feature 101, and other multiple feature samples 311 associated with the sampling feature 101 correspondingly in the database 301, as well as outputting to the second operation terminal 200 for the prompt module 220 to prompt the feature sample 311 while prompting the sampling feature 101 related thereto. Preferably, the prompt module 220 may further prompt the identification information 1011 related to the prompted sampling feature 101, and other feature sample 311 related thereto, such that the cognitive aiding training is provided for the patient of the second operation terminal 200.

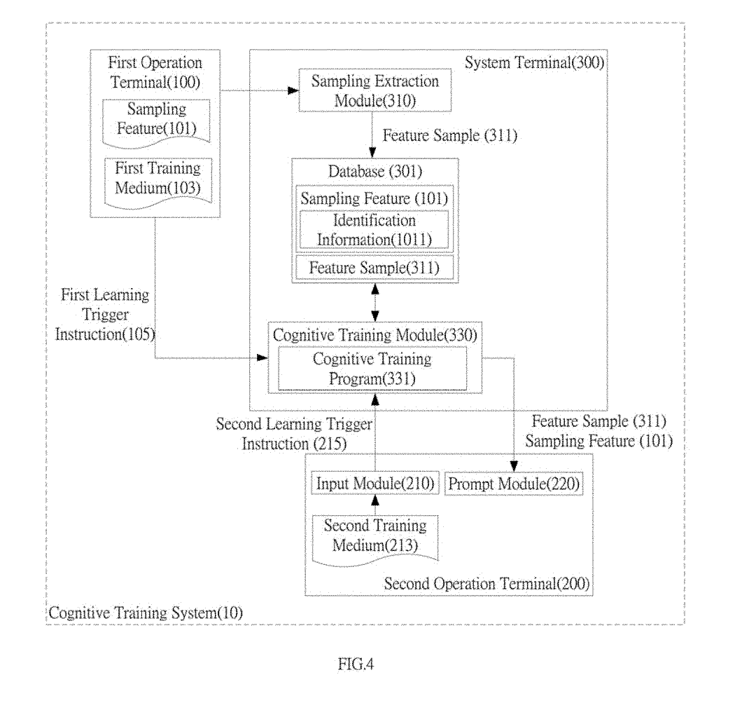

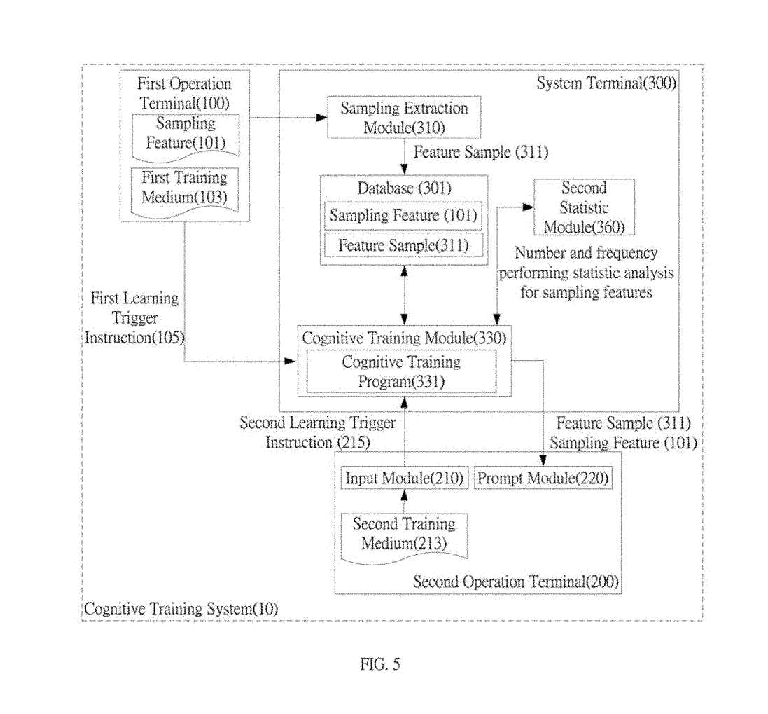

Refer to FIG. 5 continuously. In the first and second embodiments of cognitive aiding training mentioned above, preferably, the present invention further has a second statistic module 360 provided in the system terminal 300 used to perform statistic analysis with respect to number and frequency of prompts of the sampling feature 101 done by the prompt module 220 in the first embodiment as illustrated in FIG. 3. If the statistic result shows the number and the frequency of prompts of a certain sampling feature 101 are higher, then, in the second embodiment as illustrated in FIG. 4, the cognitive training module 303 provides an enhancement training or an adequate training with respect to the feature sample 311 matching with the sampling feature 101. For example, if the analysis result of the second statistic module 360 shows that the number and the frequency of prompting the sampling feature 101 as the “daughter” by the patient are higher, then it indicates closer association between the patient and the “daughter”. However, if the patient suffers from serious cognitive disorder with respect to the “daughter”, then the cognitive training module 330 may increase the output frequency of the feature sample 311 related to the “daughter” when providing the cognitive aiding training as described in the second embodiment illustrated in FIG. 4, to enhance the cognitive training of the patient with respect to the “daughter”, such that the training for the patient is more targeted in order to improve the training effect.

Moreover, as above, the prompt module 220 of the second operation terminal 200 according to the present invention may also be capable of 3D situational interaction, such as VR glasses. After the patient wear the VR glasses, the prompt module 220 prompts related information, such as the feature sample 311, by means of a three-dimensional virtual situational interaction scenario for the patient to perform touch control according to related prompts in the virtual situational interaction scenario. By this way, not only a novel and interesting treatment process may be designed, but also the motivation of the patient to participate may be improved.

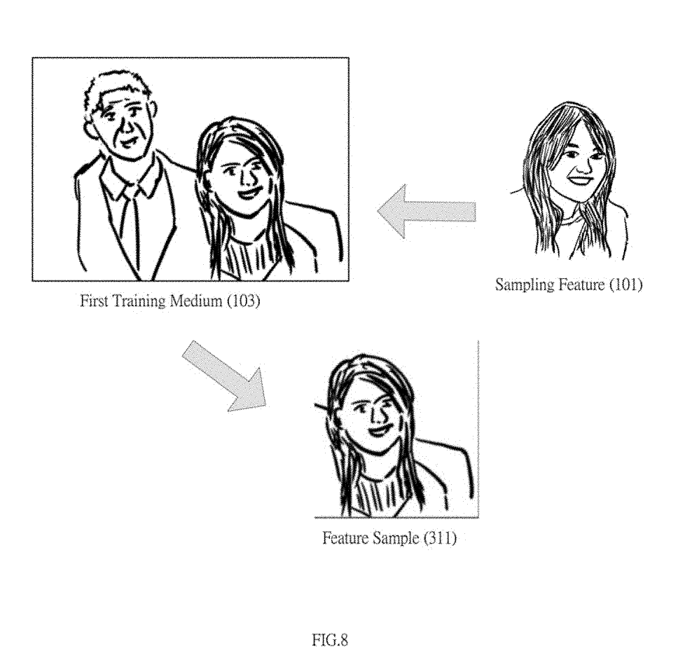

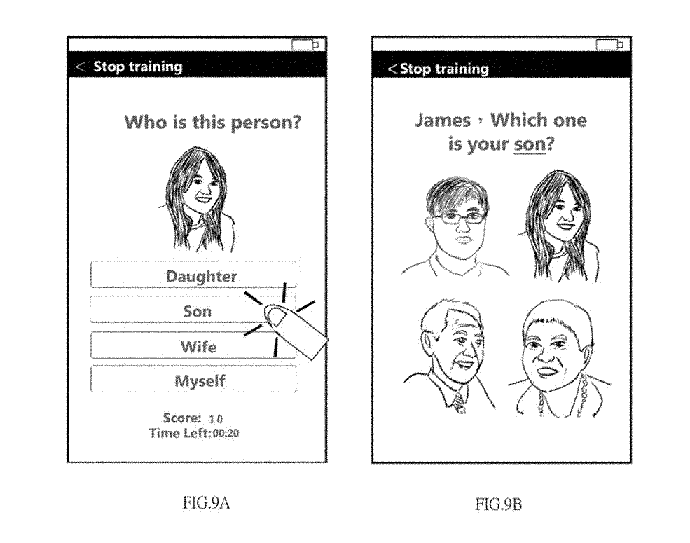

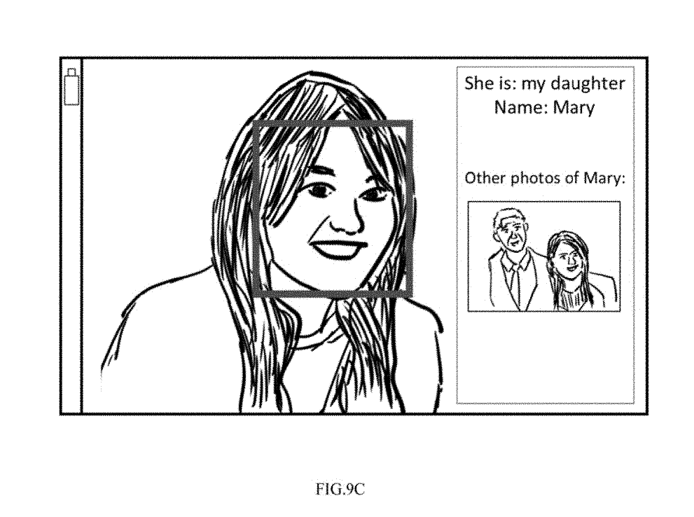

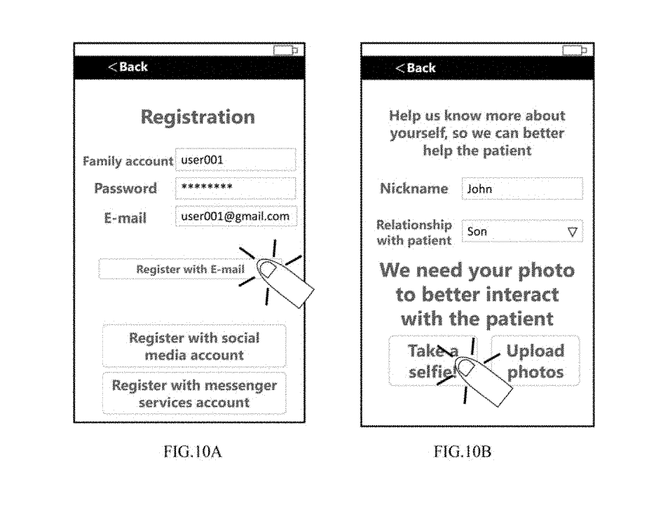

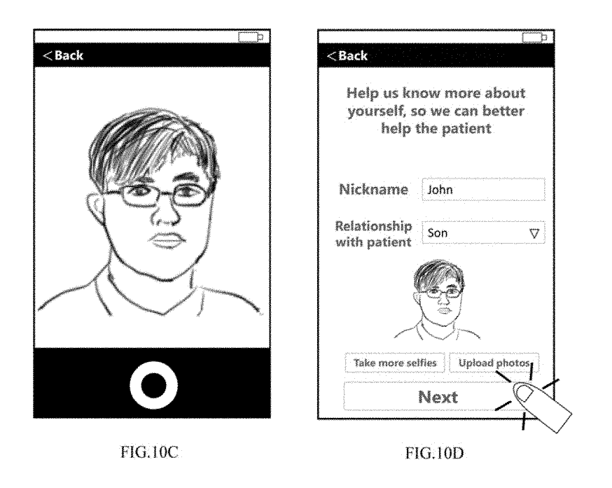

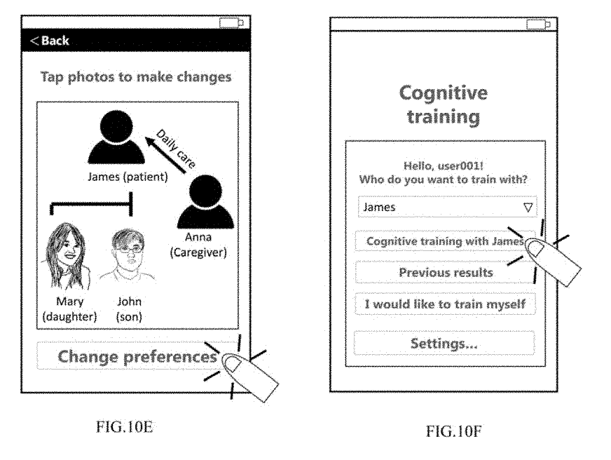

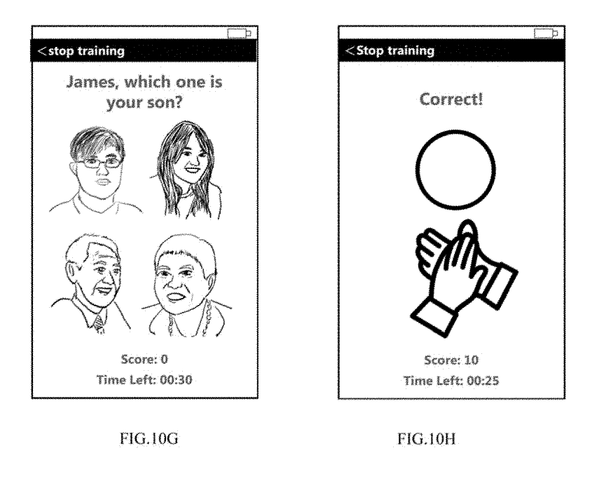

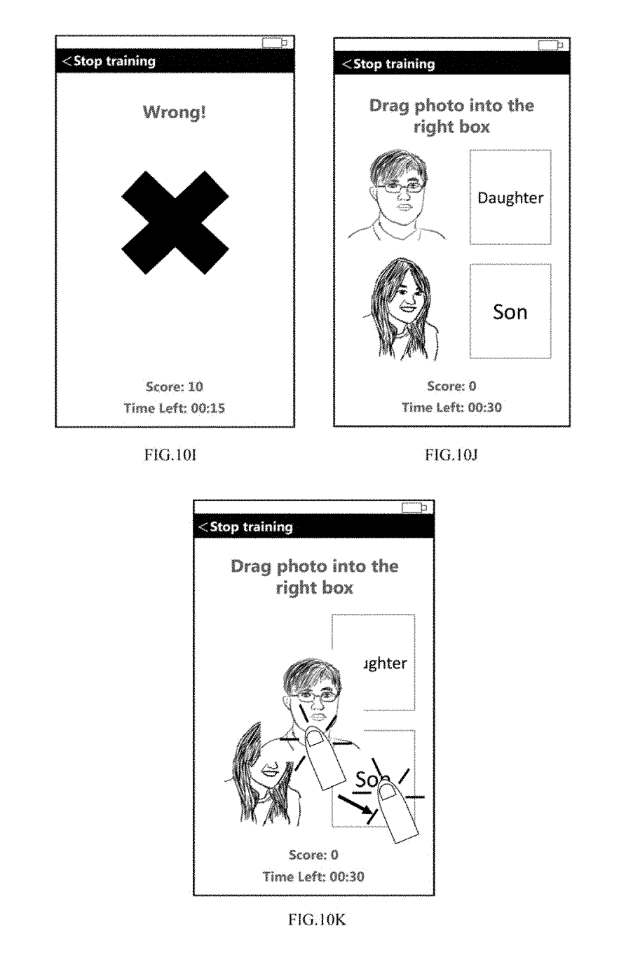

Refer to FIGS. 10A to 10K in conjunction, which are schematic views showing user operation interfaces of the cognitive training system 10 executing a cognitive training function according to the present invention. At first, go to FIG. 10A, where a user may sign up an account by the first operation terminal 100 or the second operation terminal 200; next, go to FIG. 10B, the sampling feature 101 may be input by the first operation terminal 100, for example, the user may select a way of “selfie” to retrieve and upload the sampling feature 101 (as shown in FIG. 10C); then, go to FIG. 10D, the user performs setting for the uploaded sampling feature 101, which name is defined as “John”, which relationship with the patient is defined as “son”. Further, multiple sampling features 101 are input repetitively by executing the steps illustrated in FIGS. 10B to 10D repetitively to generate a person map for the patient as shown in FIG. 10E accordingly.

In performing the cognitive training, the patient may login an interface as shown in FIG. 10F, and select “Cognitive Training” function. Wherein, there are various ways and forms for cognitive training, in which two more typical implementations are described by way of example below. In a first embodiment, the system 10 of the present invention executes a face selection game, i.e., the interface as shown in FIG. 10G, for the patient to find out the correct “son” from the four photos shown below according to the “son” prompted above. The system 10 will display the interface as shown in FIG. 10H as a positive feedback if the selection is correct, or the system 10 prompts the interface as shown in FIG. 10I as a negative feedback if the selection is incorrect. In a second embodiment, the system 10 executes a face pairing game, For example, in the interface illustrated in FIG. 10J, the system 10 displays multiple photos and multiple text prompts for the patient to perform cognitive training by dragging the photos to corresponding text prompts, as shown in FIG. 10K. With the way mentioned above, the present invention utilizes means of positive feedback, negative feedback and training associative memory to train and aid in cognitive function of the user.

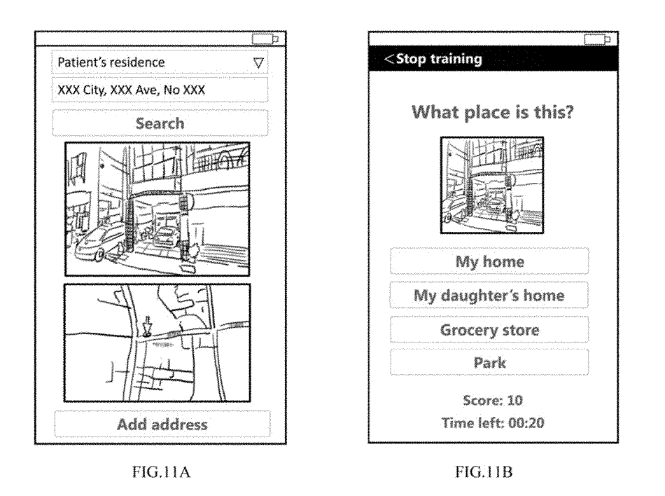

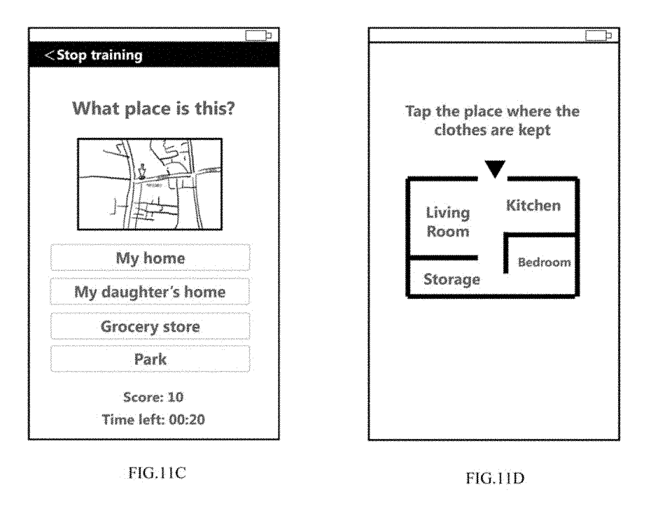

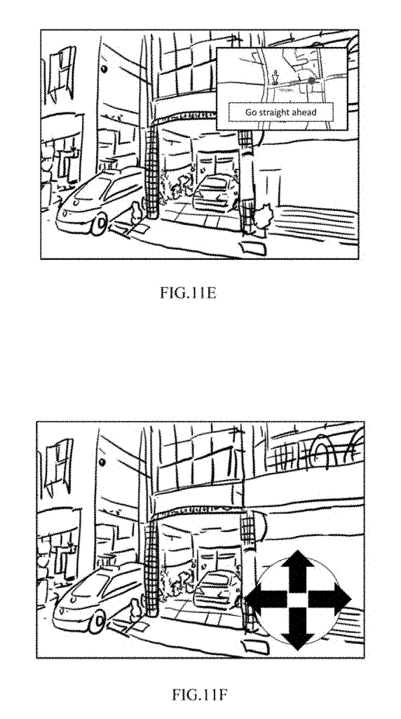

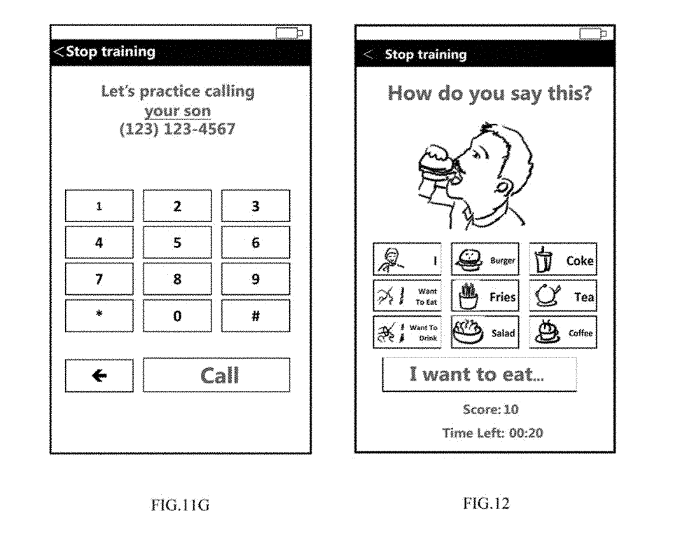

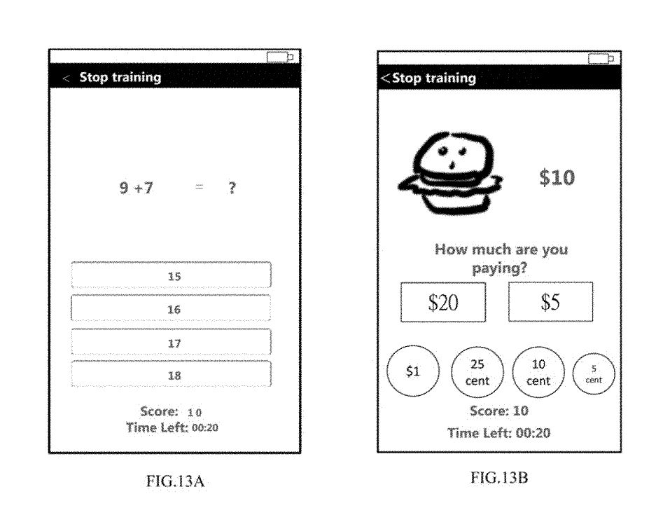

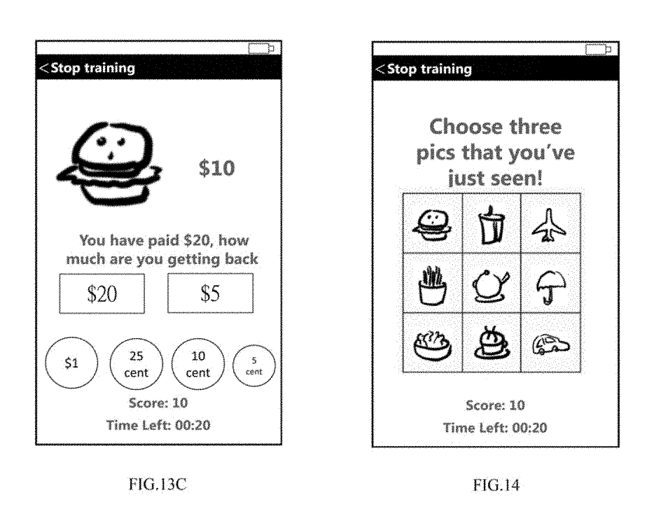

It is noted particularly that the present invention is also suitable for providing a spatial positioning ability training, an expression ability training, an execution ability training and a calculation ability training for patients with cognitive disorder. For the spatial positioning ability training, the first, second training media 103, 213 are Global Positioning System (GPS) positioning data, indoor spatial positioning data, geographical data, streetscape data; the identification information 1011 stored in the database 301 may include text, date and spatial positioning data, etc.; the cognitive training system 10 may obtain an image of a path between two places by using an algorithm to prompt the image and information of the path for the patient in order to train the ability of the patient traveling between specific places accordingly, and record the data of paths along which the patient walks really to analyze correctness of the paths along which the patient walks in order to train the ability of the patient going outside (refer to FIGS. 11A to 11F for related embodiments). For the expression ability training, the first, second training media 103, 213 are vocabulary data, grammar data or user language expression habit record data; the cognitive training system 10 may utilize language process algorithm to analyze a language expression record input by the patient, and prompt a correct expression with respect to expression ability disorder of the patient, in order to train communication ability of the patient thereby (refer to FIG. 12 for a related embodiment). For execution ability training, the first, second training media 103, 213 are procedure information (e.g., procedure of using laundry machine, procedure of calling, etc.; refer to FIG. 11G for an related embodiment) for executing a specific function; the cognitive training system 10 may analyze the procedure of a specific function carried out by the patient, followed by prompting a correct procedure with respect to the execution ability disorder of the patient, in order to train self-care ability of the patient thereby. Further, for the calculation ability training, the cognitive training system 10 performs training for calculation ability of the patient, such as simple addition or subtraction of numbers or coins (refer to FIGS. 13A to 13C for related embodiments). Furthermore, the present invention may also provide cognitive training mode of short-term memory, which embodiment is as shown in FIG. 14, to aid the patient in brain training.

In conclusion, the cognitive training system according to the present invention, wherein a cognitive training media is edited by the first operation terminal and being saved in the system terminal. The system terminal is used for sending the cognitive training media to the second operation terminal for display when receiving the first learning trigger instruction of the first operation terminal and receiving feedback information including a cognitive training result, and analyzing whether the cognitive training result is correct and returning the analysis, so as to achieve the effect of cognitive training. The system terminal may receive the second learning trigger instruction input by the second operation terminal to analyze and prompt the training aiding medium retrieved by the second operation terminal in real time, such that the service of cognitive aiding is provided for the second operation terminal accordingly. Thereby, the present invention may not only provide a customized cognitive training, but also integrate the cognitive training and actual living environment to improve the effect of the cognitive training. Next, the present invention is capable of 3D situational interaction for improving enjoyment of the training and improving motivation of the patient. Furthermore, the present invention may also perform statistical analysis for training content by the first statistic module and the second statistic module to arrange adequate trainings for weak parts, thereby memory training of the patient is enhanced, and training efficiency is improved further.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A cognitive training system, comprising:
a first operation terminal for providing input of a sampling feature, a first training medium and a first learning trigger instruction;
a second operation terminal comprising an input module and a prompt module, wherein the input module is used for providing input of a cognitive result; and
a system terminal comprising:
a database;
a sampling extraction module for extracting a feature sample matching the sampling feature from the first training medium, and storing the sampling feature and the feature sample matching therewith in the database; and
a cognitive training module for receiving the first learning trigger instruction of the first operation terminal to activate execution of a cognitive training program in order to provide a cognitive training service for the second operation terminal, and communicatively connecting with the input module and the prompt module of the second operation terminal, such that the cognitive training module triggers the cognitive training program when receiving the first learning trigger instruction for the prompt module to prompt the feature sample stored in the database, followed by receiving the cognitive result which is input by the input module based on the prompted feature sample to determine that the cognitive result is correct as the cognitive result matches with the sampling feature stored in the database, or to determine that the cognitive result is incorrect if there is mismatch.

2. The cognitive training system according to claim 1, wherein the system terminal further includes a first statistic module, which performs statistic analysis for accuracy of the cognitive result of the feature sample trained by the cognitive training module for the cognitive training module to provide an enhancement training for the feature sample of the cognitive result with lower accuracy.

3. The cognitive training system according to claim 1, wherein the input module further includes capability for providing input of a second training medium and a second learning trigger instruction; and the system terminal further includes a feature analysis module; wherein
the cognitive training module is also used for receiving the second learning trigger instruction of the second operation terminal to activate execution of the cognitive training program in order to provide a cognitive aiding service for the second operation terminal, such that the cognitive training module triggers the cognitive training program when receiving the second learning trigger instruction for the input module to input the second training medium, and extract an identification feature in the second training medium by the feature analysis module, followed by searching for a sampling feature matching with the identification feature from the database, and allowing the prompt module to prompt the sampling feature if there is match.

4. The cognitive training system according to claim 3, wherein the cognitive training module further includes trigger of the cognitive training program when receiving the first, second learning trigger instructions for the prompt module to prompt the sampling feature matching with the feature sample stored in the database when prompting the feature sample stored in the database.

5. The cognitive training system according to claim 4, wherein the system terminal further includes a second statistic module, which performs statistic analysis with respect to number and frequency of prompts of the sampling feature done by the prompt module to provide an enhancement training for the feature sample matching with the sampling feature with higher number and the frequency of prompts.

6. The cognitive training system according to claim 1, wherein the first, second training media have a dynamic image medium, a static image medium and an audio medium.

7. The cognitive training system according to claim 1, wherein the sampling feature is an image feature and/or a voice feature.

8. The cognitive training system according to claim 7, wherein the sampling feature includes the image feature and/or voice feature of at least one person and/or object, and the sampling feature further include an identification information.

9. The cognitive training system according to claim 8, wherein the cognitive training module further includes extracting the sampling feature and an identification information included therein as well as the feature sample matching with the sampling feature from the database after receiving the first learning trigger instruction for the prompt module to prompt the extracted feature sample, followed by receiving a cognitive result comprising an input identification information input by the input module, and determining whether the input identification information in the cognitive result matches with the extracted identification information.

10. The cognitive training system according to claim 8, wherein the cognitive training module further includes extracting the sampling feature and an identification information included therein as well as the feature sample matching with the sampling feature from the database after receiving the first learning trigger instruction for the prompt module to prompt the identification information, followed by receiving a cognitive result comprising an input sampling feature or an input feature sample input by the input module, and determining whether the input sampling feature or the input feature sample in the cognitive result matches with the extracted sampling feature.

11. The cognitive training system according to claim 1, wherein the cognitive training module further includes transmitting a determination information with respect to correctness or incorrectness of the cognitive result to the prompt module for display.

12. The cognitive training system according to claim 1, wherein the first operation terminal, the second operation terminal and the system terminal are mounted in one electronic device.

13. The cognitive training system according to claim 12, wherein the electronic device is a desktop electronic device or a portable electronic device.

14. The cognitive training system according to claim 1, wherein the first operation terminal, the second operation terminal and the system terminal are mounted in at least one electronic device.

15. The cognitive training system according to claim 14, wherein the electronic device for mounting the second operation terminal is a wearable electronic device.

16. The cognitive training system according to claim 15, wherein the prompt module of the second operation terminal is capable of 3D situational interaction.

17. The cognitive training system according to claim 15, wherein the first operation terminal further includes a first retrieval module for retrieving the first training medium, and the second operation terminal further includes a second retrieval module for retrieving the second training medium.
